(19) United States
(12) Patent Application Publication
(10) Pub. No.: US 2025/0058899 A1
(43) Pub. Date: Feb. 20, 2025

(54) LOW-THRUST PROPULSION VEHICLE WITH TRAJECTORY OPTIMIZATION USING MINIMUM PROPELLANT TRANSFER

(71) Applicant: Blue Origin, LLC, Kent, WA (US)

(72) Inventor: Ian Lee Elliott, Seattle, WA (US)

(21) Appl. No.: 18/793,695

(22) Filed: Aug. 2, 2024

Related U.S. Application Data
(60) Provisional application No. 63/530,886, filed on Aug. 4, 2023.

(51) Int. Cl. B64G 1/24

(52) U.S. Cl. CPC B64G 1/2427

(57) ABSTRACT

A vehicle is described herein that is capable of operating in space. The vehicle comprises a memory that stores computer-executable instructions. The vehicle further comprises a processor in communication with the memory, wherein the computer-executable instructions, when executed by the processor, cause the processor to: derive an equation of motion for the vehicle; determine an initial guess of a first value of a costate of the vehicle; determine the first value of the costate for a minimum propellant transfer in averaged orbit dynamics using the equation of motion, the initial guess, and a single shooting technique; determine a second value of the costate for the minimum propellant transfer in full-state orbit dynamics using the first value of the costate and the single shooting technique; and adjust a path of the vehicle to cause the vehicle to travel along an optimal transfer in full-state orbit dynamics.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims the benefit of U.S. Provisional Application No. 63/530,886, filed on Aug. 4, 2023, titled LOW-THRUST PROPULSION VEHICLE TRAJECTORY OPTIMIZATION, the entire contents of which is incorporated by reference herein and forms a part of this specification for all purposes.

### TECHNICAL FIELD

The present disclosure generally relates to optimizing trajectories of vehicles equipped with a low-thrust propulsion system.

### BACKGROUND

Vehicles that operate in space may have a chemical propulsion system, an electrical propulsion system, or a chemical-electrical hybrid propulsion system. For example, a vehicle with a chemical propulsion system may rely on a liquid propellant, a solid propellant, or a liquid-solid hybrid propellant that generates thrust through a chemical reaction. A vehicle with an electrical propulsion system may rely on electric heating, electric fields, or magnetic fields that generate thrust through the acceleration of propellants. Chemical propulsion systems can produce high thrusts in a given period of time, whereas electric propulsions systems can produce low thrusts in a given period of time. Thus, chemical propulsion systems are often suitable for launching vehicles or other flight operations in which a vehicle may make rapid maneuvers and/or the flight time may be short (e.g., 1 hour, 10 hours, 24 hours, etc.). On the other hand, electric propulsion systems are often suitable for transit in space (e.g., within an orbit, between orbits, etc.) in which a vehicle may not make rapid maneuvers and/or flight times may be long (e.g., 1 week, 1 month, 1 year, 5 years, etc.).

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a terrestrial-based system for determining a minimum propellant or minimum time transfer for an extraterrestrial vehicle. The terrestrial-based system comprises memory that stores computer-executable instructions. The terrestrial-based system further comprises a processor in communication with the memory, where the computer-executable instructions, when executed by the processor, cause the processor to: derive an averaged equation of motion for the extraterrestrial vehicle; determine an initial guess of a first value of a costate of the extraterrestrial vehicle; determine the first value of the costate for the minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The system of the preceding paragraph can include any sub-combination of the following features: where the computer-executable instructions, when executed by the processor, further cause the processor to determine the initial guess of the first value of the costate of the extraterrestrial vehicle as corresponding to trajectory boundary conditions of the extraterrestrial vehicle; where the computer-executable instructions, when executed by the processor, further cause the processor to determine the second value of the costate in the full-state orbit dynamics using the first value of the costate and the single shooting technique by applying multivariate root solvers to solve for a set of variables that minimize a set of constraints defined within a constraints vector; where the computer-executable instructions, when executed by the processor, further cause the processor to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position.

Another aspect of the disclosure provides non-transitory, computer-readable medium comprising computer-executable instructions, where the computer-executable instructions, when executed by a computer system, cause the computer system to derive an averaged equation of motion for an extraterrestrial vehicle; determine an initial guess of a first value of a costate of the extraterrestrial vehicle; determine the first value of the costate for a minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The computer-readable medium of the preceding paragraph can include any sub-combination of the following features: where the computer-executable instructions further include instructions, when executed by a computer system, cause the computer system to determine the initial guess of the first value of the costate of the extraterrestrial vehicle as corresponding to trajectory boundary conditions of the extraterrestrial vehicle; where the computer-executable instructions further include instructions, when executed by a computer system, cause the computer system to determine the second value of the costate in the full-state orbit dynamics using the first value of the costate and the single shooting technique by applying multivariate root solvers to solve for a set of variables that minimize a set of constraints defined within a constraints vector; where the computer-executable instructions further include instructions, when executed by a computer system, cause the computer system to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position; where the computer-executable instructions further include instructions, when executed by a computer system, cause the computer system to determine a user-specified transfer time when the averaged orbit dynamics derives in response to minimizing propellant usage for the extraterrestrial vehicle; where the computer-executable instructions further include instructions, when executed by a computer system, cause the computer system to determine the first value of the costate in the averaged orbit dynamics using the averaged equation of motion, the initial guess, the single shooting, and the user-specified transfer time; where the computer-executable instructions further include instructions, when executed by a computer system, cause the computer system to determine the first value of the costate in the averaged orbit dynamics by solving a two-point boundary value problem with the averaged equation of motion and the initial guess as inputs, where the two-point boundary value problem is solved with the single shooting technique; where the computer-executable instructions further include instructions, when executed by a computer system, cause the computer system to determine the first value of the costate for the minimum propellant transfer over a fixed-transfer time in the averaged orbit dynamics using the averaged equation of motion, the initial guess, and the single shooting technique.

Another aspect of the disclosure provides a computer implemented method, under control of a user device with a processor and memory, where the user device is located on a first station, and where computer-executable instructions, when executed by the processor, cause the user device to perform steps of: determining deriving, by a terrestrial-based system, an averaged equation of motion for the extraterrestrial vehicle; determining an initial guess of a first value of a costate of the extraterrestrial vehicle; determining the first value of the costate for a minimum propellant transfer in averaged orbit dynamics using the averaged equation of motion, the initial guess, and a single shooting technique; determining a second value of the costate for the minimum propellant transfer in full-state orbit dynamics using the first value of the costate and the single shooting technique; generating instructions for causing the extraterrestrial vehicle to travel along an optimal transfer in full-state orbit dynamics; and causing the extraterrestrial vehicle to adjust trajectory based on the generated instructions

The computer implemented method of the preceding paragraph can include any sub-combination of the following features: where determining the initial guess of the first value of the costate comprises determining the initial guess of the first value of the costate of the extraterrestrial vehicle as corresponding to trajectory boundary conditions of the extraterrestrial vehicle; where determining the second value of the costate in the full-state orbit dynamics using the first value of the costate and the single shooting technique comprises determining the second value of the costate in the full-state orbit dynamics using the first value of the costate and the single shooting technique by applying multivariate root solvers to solve for a set of variables that minimize a set of constraints defined within a constraints vector; where generating instructions for causing the extraterrestrial vehicle to travel along the optimal transfer in the full-state orbit dynamics comprises generating the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using either minimum time or minimum propellant to reach the final position; where the method further comprising determining a user-specified transfer time when the averaged orbit dynamics derives in response to minimizing propellant usage for the extraterrestrial vehicle; where the method further comprising determining the first value of the costate in the averaged orbit dynamics using the averaged equation of motion, the initial guess, the single shooting, and the user-specified transfer time; where determining the first value of the costate in the averaged orbit dynamics using the averaged equation of motion, the initial guess, and the single shooting comprises determine the first value of the costate in the averaged orbit dynamics by solving a two-point boundary value problem with the averaged equation of motion and the initial guess as inputs, where the two-point boundary value problem is solved with the single shooting technique; where determining the first value of the costate for the minimum propellant transfer in the averaged orbit dynamics using the averaged equation of motion, the initial guess, and the single shooting technique comprises determining the first value of the costate for the minimum propellant transfer over a fixed-transfer time in the averaged orbit dynamics using the averaged equation of motion, the initial guess, and the single shooting technique.

Another aspect of the disclosure provides a terrestrial-based system for determining a minimum propellant or minimum time transfer for an extraterrestrial vehicle. The terrestrial-based system comprises memory that stores computer-executable instructions. The terrestrial-based system further comprises a processor in communication with the memory, where the computer-executable instructions, when executed by the processor, cause the processor to: derive an averaged equation of motion for the extraterrestrial vehicle; determine an initial guess of a first value of a costate of the extraterrestrial vehicle; determine the first value of the costate for the minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The system of the preceding paragraph can include any sub-combination of the following features: where the computer-executable instructions, when executed by the processor, further cause the processor to determine the initial guess of the first value of the costate of the extraterrestrial vehicle as corresponding to trajectory boundary conditions of the extraterrestrial vehicle; where the computer-executable instructions, when executed by the processor, further cause the processor to determine the second value of the costate in the full-state orbit dynamics using the first value of the costate and the single shooting technique by applying multivariate root solvers to solve for a set of variables that minimize a set of constraints defined within a constraints vector; where the computer-executable instructions, when executed by the processor, further cause the processor to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position.

Another aspect of the disclosure provides non-transitory, computer-readable medium comprising computer-executable instructions, where the computer-executable instructions, when executed by a computer system, cause the computer system to derive an averaged equation of motion for an extraterrestrial vehicle; determine an initial guess of a first value of a costate of the extraterrestrial vehicle; determine the first value of the costate for a minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The computer-readable medium of the preceding paragraph can include any sub-combination of the following features: where the computer-executable instructions further include instructions, when executed by a computer system, cause the computer system to determine the initial guess of the first value of the costate of the extraterrestrial vehicle as corresponding to trajectory boundary conditions of the extraterrestrial vehicle; where the computer-executable instructions further include instructions, when executed by a computer system, cause the computer system to determine the second value of the costate in the full-state orbit dynamics using the first value of the costate and the single shooting technique by applying multivariate root solvers to solve for a set of variables that minimize a set of constraints defined within a constraints vector; where the computer-executable instructions further include instructions, when executed by a computer system, cause the computer system to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position; where the computer-executable instructions further include instructions, when executed by a computer system, cause the computer system to determine a user-specified transfer time when the averaged orbit dynamics derives in response to minimizing propellant usage for the extraterrestrial vehicle; where the computer-executable instructions further include instructions, when executed by a computer system, cause the computer system to determine the first value of the costate in the averaged orbit dynamics using the averaged equation of motion, the initial guess, the single shooting, and the user-specified transfer time; where the computer-executable instructions further include instructions, when executed by a computer system, cause the computer system to determine the first value of the costate in the averaged orbit dynamics by solving a two-point boundary value problem with the averaged equation of motion and the initial guess as inputs, where the two-point boundary value problem is solved with the single shooting technique; where the computer-executable instructions further include instructions, when executed by a computer system, cause the computer system to determine the first value of the costate for the minimum propellant transfer over a fixed-transfer time in the averaged orbit dynamics using the averaged equation of motion, the initial guess, and the single shooting technique.

Another aspect of the disclosure provides a computer implemented method, under control of a user device with a processor and memory, where the user device is located on a first station, and where computer-executable instructions, when executed by the processor, cause the user device to perform steps of: determining deriving, by a terrestrial-based system, an averaged equation of motion for the extraterrestrial vehicle; determining an initial guess of a first value of a costate of the extraterrestrial vehicle; determining the first value of the costate for a minimum propellant transfer in averaged orbit dynamics using the averaged equation of motion, the initial guess, and a single shooting technique; determining a second value of the costate for the minimum propellant transfer in full-state orbit dynamics using the first value of the costate and the single shooting technique; generating instructions for causing the extraterrestrial vehicle to travel along an optimal transfer in full-state orbit dynamics; and causing the extraterrestrial vehicle to adjust trajectory based on the generated instructions

The computer implemented method of the preceding paragraph can include any sub-combination of the following features: where determining the initial guess of the first value of the costate comprises determining the initial guess of the first value of the costate of the extraterrestrial vehicle as corresponding to trajectory boundary conditions of the extraterrestrial vehicle; where determining the second value of the costate in the full-state orbit dynamics using the first value of the costate and the single shooting technique comprises determining the second value of the costate in the full-state orbit dynamics using the first value of the costate and the single shooting technique by applying multivariate root solvers to solve for a set of variables that minimize a set of constraints defined within a constraints vector; where generating instructions for causing the extraterrestrial vehicle to travel along the optimal transfer in the full-state orbit dynamics comprises generating the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using either minimum time or minimum propellant to reach the final position; where the method further comprising determining a user-specified transfer time when the averaged orbit dynamics derives in response to minimizing propellant usage for the extraterrestrial vehicle; where the method further comprising determining the first value of the costate in the averaged orbit dynamics using the averaged equation of motion, the initial guess, the single shooting, and the user-specified transfer time; where determining the first value of the costate in the averaged orbit dynamics using the averaged equation of motion, the initial guess, and the single shooting comprises determine the first value of the costate in the averaged orbit dynamics by solving a two-point boundary value problem with the averaged equation of motion and the initial guess as inputs, where the two-point boundary value problem is solved with the single shooting technique; where determining the first value of the costate for the minimum propellant transfer in the averaged orbit dynamics using the averaged equation of motion, the initial guess, and the single shooting technique comprises determining the first value of the costate for the minimum propellant transfer over a fixed-transfer time in the averaged orbit dynamics using the averaged equation of motion, the initial guess, and the single shooting technique.

Another aspect of the disclosure provides a terrestrial-based system for determining a minimum propellant or minimum time transfer for an extraterrestrial vehicle. The terrestrial-based system comprises memory that stores computer-executable instructions. The terrestrial-based system further comprises a processor in communication with the memory, where the computer-executable instructions, when executed by the processor, cause the processor to: derive an averaged equation of motion for the extraterrestrial vehicle; determine an initial guess of a first value of a costate of the extraterrestrial vehicle; determine the first value of the costate for the minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The system of the preceding paragraph can include any sub-combination of the following features: where the computer-executable instructions, when executed by the processor, further cause the processor to determine the initial guess of the first value of the costate of the extraterrestrial vehicle as corresponding to trajectory boundary conditions of the extraterrestrial vehicle; where the computer-executable instructions, when executed by the processor, further cause the processor to determine the second value of the costate in the full-state orbit dynamics using the first value of the costate and the single shooting technique by applying multivariate root solvers to solve for a set of variables that minimize a set of constraints defined within a constraints vector; where the computer-executable instructions, when executed by the processor, further cause the processor to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position.

Another aspect of the disclosure provides non-transitory, computer-readable medium comprising computer-executable instructions, where the computer-executable instructions, when executed by a computer system, cause the computer system to derive an averaged equation of motion for an extraterrestrial vehicle; determine an initial guess of a first value of a costate of the extraterrestrial vehicle; determine the first value of the costate for a minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The computer-readable medium of the preceding paragraph can include any sub-combination of the following features: where the computer-executable instructions further include instructions, when executed by a computer system, cause the computer system to determine the initial guess of the first value of the costate of the extraterrestrial vehicle as corresponding to trajectory boundary conditions of the extraterrestrial vehicle; where the computer-executable instructions further include instructions, when executed by a computer system, cause the computer system to determine the second value of the costate in the full-state orbit dynamics using the first value of the costate and the single shooting technique by applying multivariate root solvers to solve for a set of variables that minimize a set of constraints defined within a constraints vector; where the computer-executable instructions further include instructions, when executed by a computer system, cause the computer system to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position; where the computer-executable instructions further include instructions, when executed by a computer system, cause the computer system to determine a user-specified transfer time when the averaged orbit dynamics derives in response to minimizing propellant usage for the extraterrestrial vehicle; where the computer-executable instructions further include instructions, when executed by a computer system, cause the computer system to determine the first value of the costate in the averaged orbit dynamics using the averaged equation of motion, the initial guess, the single shooting, and the user-specified transfer time; where the computer-executable instructions further include instructions, when executed by a computer system, cause the computer system to determine the first value of the costate in the averaged orbit dynamics by solving a two-point boundary value problem with the averaged equation of motion and the initial guess as inputs, where the two-point boundary value problem is solved with the single shooting technique; where the computer-executable instructions further include instructions, when executed by a computer system, cause the computer system to determine the first value of the costate for the minimum propellant transfer over a fixed-transfer time in the averaged orbit dynamics using the averaged equation of motion, the initial guess, and the single shooting technique.

Another aspect of the disclosure provides a computer implemented method, under control of a user device with a processor and memory, where the user device is located on a first station, and where computer-executable instructions, when executed by the processor, cause the user device to perform steps of: determining deriving, by a terrestrial-based system, an averaged equation of motion for the extraterrestrial vehicle; determining an initial guess of a first value of a costate of the extraterrestrial vehicle; determining the first value of the costate for a minimum propellant transfer in averaged orbit dynamics using the averaged equation of motion, the initial guess, and a single shooting technique; determining a second value of the costate for the minimum propellant transfer in full-state orbit dynamics using the first value of the costate and the single shooting technique; generating instructions for causing the extraterrestrial vehicle to travel along an optimal transfer in full-state orbit dynamics; and causing the extraterrestrial vehicle to adjust trajectory based on the generated instructions

The computer implemented method of the preceding paragraph can include any sub-combination of the following features: where determining the initial guess of the first value of the costate comprises determining the initial guess of the first value of the costate of the extraterrestrial vehicle as corresponding to trajectory boundary conditions of the extraterrestrial vehicle; where determining the second value of the costate in the full-state orbit dynamics using the first value of the costate and the single shooting technique comprises determining the second value of the costate in the full-state orbit dynamics using the first value of the costate and the single shooting technique by applying multivariate root solvers to solve for a set of variables that minimize a set of constraints defined within a constraints vector; where generating instructions for causing the extraterrestrial vehicle to travel along the optimal transfer in the full-state orbit dynamics comprises generating the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using either minimum time or minimum propellant to reach the final position; where the method further comprising determining a user-specified transfer time when the averaged orbit dynamics derives in response to minimizing propellant usage for the extraterrestrial vehicle; where the method further comprising determining the first value of the costate in the averaged orbit dynamics using the averaged equation of motion, the initial guess, the single shooting, and the user-specified transfer time; where determining the first value of the costate in the averaged orbit dynamics using the averaged equation of motion, the initial guess, and the single shooting comprises determine the first value of the costate in the averaged orbit dynamics by solving a two-point boundary value problem with the averaged equation of motion and the initial guess as inputs, where the two-point boundary value problem is solved with the single shooting technique; where determining the first value of the costate for the minimum propellant transfer in the averaged orbit dynamics using the averaged equation of motion, the initial guess, and the single shooting technique comprises determining the first value of the costate for the minimum propellant transfer over a fixed-transfer time in the averaged orbit dynamics using the averaged equation of motion, the initial guess, and the single shooting technique.

Another aspect of the disclosure provides a terrestrial-based system for determining a minimum propellant or minimum time transfer for an extraterrestrial vehicle. The terrestrial-based system comprises memory that stores computer-executable instructions. The terrestrial-based system further comprises a processor in communication with the memory, where the computer-executable instructions, when executed by the processor, cause the processor to: derive an averaged equation of motion for the extraterrestrial vehicle; determine an initial guess of a first value of a costate of the extraterrestrial vehicle; determine the first value of the costate for the minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The system of the preceding paragraph can include any sub-combination of the following features: where the computer-executable instructions, when executed by the processor, further cause the processor to determine the initial guess of the first value of the costate of the extraterrestrial vehicle as corresponding to trajectory boundary conditions of the extraterrestrial vehicle; where the computer-executable instructions, when executed by the processor, further cause the processor to determine the second value of the costate in the full-state orbit dynamics using the first value of the costate and the single shooting technique by applying multivariate root solvers to solve for a set of variables that minimize a set of constraints defined within a constraints vector; where the computer-executable instructions, when executed by the processor, further cause the processor to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position.

Another aspect of the disclosure provides non-transitory, computer-readable medium comprising computer-executable instructions, where the computer-executable instructions, when executed by a computer system, cause the computer system to derive an averaged equation of motion for an extraterrestrial vehicle; determine an initial guess of a first value of a costate of the extraterrestrial vehicle; determine the first value of the costate for a minimum propellant transfer in averaged orbit dynamics using the averaged equation of motion, the initial guess, and a single shooting technique; determine a second value of the costate for the minimum propellant transfer in full-state orbit dynamics using the first value of the costate and the single shooting technique; generate instructions for causing the extraterrestrial vehicle to travel along an optimal transfer in full-state orbit dynamics; and cause the extraterrestrial vehicle to adjust trajectory based on the generated instructions.

The computer-readable medium of the preceding paragraph can include any sub-combination of the following features: where the computer-executable instructions further include instructions, when executed by a computer system, cause the computer system to determine the initial guess of the first value of the costate of the extraterrestrial vehicle as corresponding to trajectory boundary conditions of the extraterrestrial vehicle; where the computer-executable instructions further include instructions, when executed by a computer system, cause the computer system to determine the second value of the costate in the full-state orbit dynamics using the first value of the costate and the single shooting technique by applying multivariate root solvers to solve for a set of variables that minimize a set of constraints defined within a constraints vector; where the computer-executable instructions further include instructions, when executed by a computer system, cause the computer system to generate the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using minimum propellant to reach the final position; where the computer-executable instructions further include instructions, when executed by a computer system, cause the computer system to determine a user-specified transfer time when the averaged orbit dynamics derives in response to minimizing propellant usage for the extraterrestrial vehicle; where the computer-executable instructions further include instructions, when executed by a computer system, cause the computer system to determine the first value of the costate in the averaged orbit dynamics using the averaged equation of motion, the initial guess, the single shooting, and the user-specified transfer time; where the computer-executable instructions further include instructions, when executed by a computer system, cause the computer system to determine the first value of the costate in the averaged orbit dynamics by solving a two-point boundary value problem with the averaged equation of motion and the initial guess as inputs, where the two-point boundary value problem is solved with the single shooting technique; where the computer-executable instructions further include instructions, when executed by a computer system, cause the computer system to determine the first value of the costate for the minimum propellant transfer over a fixed-transfer time in the averaged orbit dynamics using the averaged equation of motion, the initial guess, and the single shooting technique.

Another aspect of the disclosure provides a computer implemented method, under control of a user device with a processor and memory, where the user device is located on a first station, and where computer-executable instructions, when executed by the processor, cause the user device to perform steps of: determining deriving, by a terrestrial-based system, an averaged equation of motion for the extraterrestrial vehicle; determining an initial guess of a first value of a costate of the extraterrestrial vehicle; determining the first value of the costate for a minimum propellant transfer in averaged orbit dynamics using the averaged equation of motion, the initial guess, and a single shooting technique; determining a second value of the costate for the minimum propellant transfer in full-state orbit dynamics using the first value of the costate and the single shooting technique; generating instructions for causing the extraterrestrial vehicle to travel along an optimal transfer in full-state orbit dynamics; and causing the extraterrestrial vehicle to adjust trajectory based on the generated instructions

The computer implemented method of the preceding paragraph can include any sub-combination of the following features: where determining the initial guess of the first value of the costate comprises determining the initial guess of the first value of the costate of the extraterrestrial vehicle as corresponding to trajectory boundary conditions of the extraterrestrial vehicle; where determining the second value of the costate in the full-state orbit dynamics using the first value of the costate and the single shooting technique comprises determining the second value of the costate in the full-state orbit dynamics using the first value of the costate and the single shooting technique by applying multivariate root solvers to solve for a set of variables that minimize a set of constraints defined within a constraints vector; where generating instructions for causing the extraterrestrial vehicle to travel along the optimal transfer in the full-state orbit dynamics comprises generating the instructions for causing the extraterrestrial vehicle to travel along the optimal transfer in the full-state orbit dynamics including a path between an initial position and a final position for the extraterrestrial vehicle to follow, where the path corresponds to the extraterrestrial vehicle using either minimum time or minimum propellant to reach the final position; where the method further comprising determining a user-specified transfer time when the averaged orbit dynamics derives in response to minimizing propellant usage for the extraterrestrial vehicle; where the method further comprising determining the first value of the costate in the averaged orbit dynamics using the averaged equation of motion, the initial guess, the single shooting, and the user-specified transfer time; where determining the first value of the costate in the averaged orbit dynamics using the averaged equation of motion, the initial guess, and the single shooting comprises determine the first value of the costate in the averaged orbit dynamics by solving a two-point boundary value problem with the averaged equation of motion and the initial guess as inputs, where the two-point boundary value problem is solved with the single shooting technique; where determining the first value of the costate for the minimum propellant transfer in the averaged orbit dynamics using the averaged equation of motion, the initial guess, and the single shooting technique comprises determining the first value of the costate for the minimum propellant transfer over a fixed-transfer time in the averaged orbit dynamics using the averaged equation of motion, the initial guess, and the single shooting technique.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative operating environment in which a terrestrial-based computing system determines, for an extraterrestrial vehicle, a minimum time or fixed-time, minimum propellant transfer about a central body and/or between orbits using a two-step approach.

FIG. 2 is a flow diagram depicting an example minimum time or propellant transfer determination routine illustratively implemented by a terrestrial-based computing system, according to one embodiment.

FIG. 3 is a diagram of illustrative data flows and interactions between an extraterrestrial vehicle and a terrestrial-based computing system to determine a trajectory change for the extraterrestrial vehicle to adjust an orbital path.

FIG. 4 is a block diagram of an illustrative operating environment in which a space-based computing system determines, for an extraterrestrial vehicle, a minimum time or fixed-time, minimum propellant transfer about a central body and/or between orbits using a two-step approach.

FIG. 5 is a flow diagram depicting an example minimum time or propellant transfer determination routine illustratively implemented by a space-based computing system, according to one embodiment.

FIG. 6 is a diagram of illustrative data flows and interactions between an extraterrestrial vehicle and a space-based computing system to determine a trajectory change for the extraterrestrial vehicle to adjust an orbital path.

### DETAILED DESCRIPTION OF SPECIFIC EMBODIMENTS

As described above, electric propulsion systems generally produce low thrusts and are therefore suitable for vehicles traveling in space along trajectories in which rapid maneuvers are not involved. For example, a vehicle with an electric propulsion system may receive a command to travel from point A in space (e.g., a first position in a first orbit) to point B in space (e.g., a second position in the first orbit, a first position in a second orbit, etc.) along a certain trajectory. Given the limited amount of propellant that may be available onboard the vehicle, it is often desirable to select a trajectory for the vehicle that minimizes propellant or fuel usage or transmit time.

Determining a trajectory that minimizes propellant or fuel usage or transmit time can be difficult, however. The number of parameters involved in accurately modeling the physical environment in which the vehicle may be traveling may be extensive and it can be difficult to identify all of the various perturbations (e.g., gravitational forces, cosmic winds, solar storms, etc.) that can affect the trajectory of the vehicle between point A and point B. In addition, the time it may take a vehicle with an electric propulsion system to travel from point A to point B may be on the order of hundreds of days. Determination of the trajectory, however, may involve determining maneuvers of the vehicle second by second or minute by minute. For example, vehicles with electric propulsion have low thrust magnitude characteristics, which means that determination of the trajectory may involve determining tens of thousands of revolution transfer spirals. As a result, the amount of computational time it may take a typical computing system to attempt to model the physical environment and determine a trajectory can be very lengthy (e.g., multiple days, multiple weeks, etc.).

In fact, despite the amount of computational time it may take a typical computing system to attempt to model the physical environment, the resulting model is often a rough approximation of the physical environment given various unknown parameters that can affect the trajectory of the vehicle (e.g., perturbations, other forces, etc.). Such rough approximations can be problematic because it may result in vehicles slowly deviating from the optimal transfer or trajectory (e.g., a transfer in which propellant usage or travel time is minimized). Typical computing systems may therefore have to determine the optimal transfer or trajectory more often to course-correct the vehicles, resulting in even more computational resources and time being allocated to determining a transfer or trajectory that minimizes propellant or transit time.

The technical issue described above is often referred to as the many-revolution, low thrust orbital transfer problem, and is often cast as an optimal control two-point boundary value problem (TPBVP). To overcome the TPBVP, some conventional systems use indirect optimization, direct optimization, differential dynamic programming, heuristic methods, or convex programming methods. Indirect optimization is the application of the calculus of variations and Pontryagin's Minimum Principle to determine optimal thrust direction. While indirect optimization may produce low thrust trajectory optimization and increased accuracy, indirect optimization is less robust, takes an average amount of processing time to determine, and is inflexible. For example, the costates in indirect optimization are generally unintuitive and highly sensitive. Direct optimization involves directly altering the thrust direction and magnitude at nodes along the trajectory. While direct optimization may be flexible, direct optimization has average robustness and optimality, takes a high amount of processing time to determine, and produces inaccurate results. For example, direct optimization can suffer from large problem dimensions. Differential dynamic programming operates on the principal of independent time-to-go cost(s) from each node while leveraging collocation. While differential dynamic programming may be robust, has high optimality, and is accurate, differential dynamic programming has average flexibility and takes a high amount of processing time. For example, differential dynamic programming can suffer from problem size. Heuristic methods can be fast to process and intuitive to implement, but often result in a suboptimal orbit transfer trajectory. Successive convex methods are also often fast to process, but can be limited on accuracy and difficult to incorporate complex constraints.

Accordingly, the present disclosure is directed to a new process for solving low-thrust transfers (e.g., for solving the TPBVP) in a manner that realizes the technical benefits of indirect optimization, direct optimization, differential dynamic programming, heuristic methods, and convex programming methods without the technical deficiencies described above. For example, a terrestrial-based computing system (or a vehicle traveling in space) can apply a two-step process that (1) solves an optimal transfer in averaged orbit dynamics (e.g., performs orbit averaging); and (2) uses the solution of the averaged problem to solve the non-averaged full-state problem. The two-step process described herein is designed to optimize both minimum time and fixed-time, minimum propellant transfers about a central body (e.g., any celestial body, such as a planet, a moon, a star, a comet, an asteroid, etc.) and/or between orbits (e.g., between two or more central bodies, between two orbits about a central body, etc.). Optionally, the two-step process described herein can optimize either minimum time or fixed-time, minimum propellant transfers with perturbations (e.g., J2, third body effects, engine shutoff, etc.) during eclipses of the central body. The terrestrial-based computing system (or the vehicle traveling in space) can solve the two-point boundary value problems via single shooting and numerical integration to determine initial costates and/or other transfer variables, such as transfer time. The functionality implemented by the terrestrial-based computing system (or the vehicle traveling in space) may be suited to solve transfers with long trip times (e.g., transfers by vehicles with electric or hybrid propulsion) because the dimensionality of the optimal control problem may not increase with transfer time, number of revolutions, and/or number of maneuvers.

While the present disclosure describes a terrestrial-based computing system as executing the two-step process described herein, this is for illustrative purposes and is not meant to be limiting. For example, a vehicle traveling in space may include one or more processors and memory that store computer-executable instructions, where the computer-executable instructions, when executed by the processor(s), cause the processor(s) to implement the two-step process described herein. In this example, a vehicle itself may be able to determine a minimum time or a fixed-time, minimum propellant transfer between two orbits, about a central body, etc.

The terrestrial-based computing system can formulate the orbit averaging such that the hand-off between averaged and full-state optimization is completed in a single continuation step. Solving the averaged optimal control problem before solving the full-state problem serves to both increase the radius of convergence of optimization and decrease overall computation time of the terrestrial-based computing system. In fact, the terrestrial-based computing system is not required to make an initial guess for costates or perform a randomized costate search to obtain a solution. Instead, the terrestrial-based computing system can automatically generate an initial guess for costates based on the boundary conditions (e.g., based on the results of performing orbit averaging). As a result, the terrestrial-based computing system involves minimal user input before the optimization process is executed. Furthermore, the orbit averaging solution can provide valuable preliminary insight in to the full-state solution, and the calculation of the orbit averaging solution by the terrestrial-based computing system can take a fraction of the computational time that may be taken by a computing system in calculating the full-state solution.

The foregoing aspects and many of the attendant advantages of this disclosure will become more readily appreciated as the same become better understood by reference to the following detailed description, when taken in conjunction with the accompanying drawings.

### Example Low-Thrust Propulsion Vehicle Trajectory Optimization

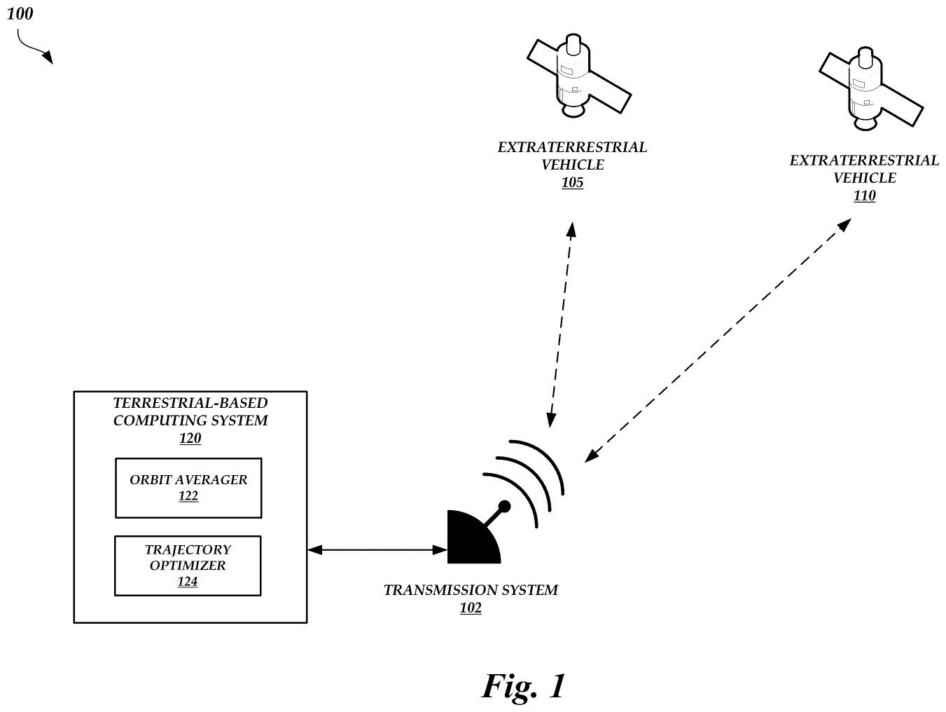

FIG. 1 is a block diagram of an illustrative operating environment 100 in which a terrestrial-based computing system 120 determines, for an extraterrestrial vehicle 110, a minimum time or fixed-time, minimum propellant transfer about a central body and/or between orbits using a two-step approach. The extraterrestrial vehicle 105 or 110 may be a space lander (e.g., a lander configured to land on a celestial body, such as a moon, a planet, an asteroid, etc.), a rover, a rocket, a satellite, a spaceship, a space shuttle, and/or any other type of vehicle that is capable of operating in space and/or on an extraterrestrial object other than Earth. The operating environment 100 further includes a transmission system 102 and at least one other extraterrestrial vehicle 105. The extraterrestrial vehicles 105 and/or 110 may also be referred to herein as “spacecraft.” As described herein, “space” may include outer space or any location outside of Earth's orbit. For example, “space” may be with respect to an extraterrestrial vehicle traveling in low-Earth orbit (LEO), geostationary orbit (GEO), or interstellar travel with or without interaction with a terrestrial-based system.

The transmission system 102 may include one or more antennas, one or more radio telescopes, and/or any other transmission equipment that is capable of transmitting or beaming a signal from Earth to a vehicle, such as the extraterrestrial vehicles 105 and/or 110, traveling in space. As described in greater detail below, the terrestrial-based computing system 120 is configured to generate instructions that, when executed by an extraterrestrial vehicle 110, causes the extraterrestrial vehicle 110 to travel along a certain trajectory. The terrestrial-based computing system 120 may be in communication with the transmission system 102 and may transmit generated instructions to the transmission system 102 so that the transmission system 102 can transmit the generated instructions to an extraterrestrial vehicle 105 and/or 110 traveling in space. In some cases, in response to receiving the generated instructions, the extraterrestrial vehicle 105, 110 (either independently or together) may perform an action. For example, the extraterrestrial vehicle 105 may adjust an orbital trajectory in response to receiving the generated instructions. In some cases, the extraterrestrial vehicle 105 may adjust from an initial trajectory to an updated trajectory that is different than the initial trajectory.

Like the extraterrestrial vehicle 110, the extraterrestrial vehicle 105 may be a space lander (e.g., a lander configured to land on a celestial body, such as a moon, a planet, an asteroid, etc.), a rover, a rocket, a satellite, a spaceship, a space shuttle, and/or any other type of vehicle that is capable of operating in space and/or on an extraterrestrial object other than Earth.

The extraterrestrial vehicle 110 may include an electric propulsion system or a chemical-electric hybrid propulsion system. Thus, the extraterrestrial vehicle 110 may operate in a low-thrust environment. The extraterrestrial vehicle 105, however, may include an electric propulsion system, a chemical propulsion system, or a chemical-electric hybrid propulsion system. Thus, the extraterrestrial vehicle 105 may operate in a low-thrust and/or a high-thrust environment.

The terrestrial-based computing system 120 can be a computing system configured to generate instructions that cause an extraterrestrial vehicle 110 to travel along a certain trajectory that may minimize travel time or fuel usage when the extraterrestrial vehicle 110 is attempting to reach point B from point A while in space. The terrestrial-based computing system 120 may be a single computing device, or it may include multiple distinct computing devices, such as computer servers, logically or physically grouped together to collectively operate as a server system. The components of the terrestrial-based computing system 120 can each be implemented in application-specific hardware (e.g., a server computing device with one or more ASICs) such that no software is necessary, or as a combination of hardware and software. In addition, the modules and components of the terrestrial-based computing system 120 can be combined on one server computing device or separated individually or into groups on several server computing devices. In some embodiments, the terrestrial-based computing system 120 may include additional or fewer components than illustrated in FIG. 1.

The terrestrial-based computing system 120 may include various modules, components, data stores, and/or the like to provide the motion planning functionality described herein. For example, the terrestrial-based computing system 120 may include an orbit averager 122 and a trajectory optimizer 124.

The terrestrial-based computing system 120 can use modified equinoctial elements (MEEs) as a primary representation of the state of the extraterrestrial vehicle 110 relative to a central body for the operations described herein. For example, the terrestrial-based computing system 120 may calculate some or all of equations (1)-(34) described below based on known or obtained parameter values associated with the extraterrestrial vehicle 110 (e.g., the terrestrial-based computing system 120 may obtain parameter values associated with the extraterrestrial vehicle 110 from the extraterrestrial vehicle 110 itself, from one or more sensors located in space, from a separate terrestrial-based system, not shown, etc.).

Generally, MEEs are applied to low-thrust trajectory design because MEEs do not possess singularities for circular orbits or zero-inclination orbits. In a two-body environment, the MEE description of the extraterrestrial vehicle 110 can include five constant values and/or one time-varying anomaly (e.g., “fast variable”). Using MEEs, a state vector, x, may be defined as

$$x = {[ p , f , g , h , k , L ]}^{T} \qquad ( 1 )$$

where the time-varying variable, L, may be the true longitude of the extraterrestrial vehicle 110. The uncontrolled rate-of-change of the state variables in a two-body environment motion may be captured within a natural element rates vector, f, expressed in terms of MEEs as

$$f = {[ 0 , 0 , 0 , 0 , 0 , \sqrt{u p} {( w / p )}^{2} ]}^{T} \qquad ( 2 )$$

where μ is the gravitational parameter of the central body and

$$w = 1 + f cos ( L ) + g sin ( L ) \qquad ( 3 )$$

Thrust produced by the extraterrestrial vehicle 110 may cause a degradation in the mass, m, of the extraterrestrial vehicle 110, which may be governed by the mass flow rate equation defined as

$$\dot{m} = - \frac{{σ}_{e} ‖ u ‖ m}{{v}_{e}} \qquad ( 4 )$$

where lull may be the magnitude of the acceleration of the extraterrestrial vehicle 110 due to thrust control. Exhaust velocity, vₑ, may be defined as goIₛₚ, where Iₛₚ may be the specific impulse of the propulsion system of the extraterrestrial vehicle 110 and go may be standard gravity, 9.80665 m/s2. The term σₑ may be a throttling factor determined by the terrestrial-based computing system 120 using a penumbra shadow model of the central body (which may be obtained from and/or determined by a separate terrestrial-based system, not shown), such that the extraterrestrial vehicle 110, in response to receiving instructions from the terrestrial-based computing system 120, throttles down to zero within an eclipse. Throttling due to the optimal control law may be contained within the control acceleration vector, u.

The terrestrial-based computing system 120 may consider several perturbations in performing the calculations described herein, including J₂, third-body gravity, and/or throttling due to eclipsing by the central body. The terrestrial-based computing system 120 may express a Cartesian acceleration vector in the local radial, tangent, normal (RTN) frame of the extraterrestrial vehicle 110. This coordinate frame may be defined with unit vectors, {ôᵣ,ô_{θ},ôₕ}, defined as

$$\begin{matrix}{\hat{o}}_{r} = \frac{r}{‖ r ‖} , & {\hat{o}}_{θ} = {\hat{o}}_{h} \times {\hat{o}}_{r} , & {\hat{o}}_{h} = \frac{r \times v}{‖ r \times v ‖}\end{matrix} \qquad ( 5 )$$

where r and v are the inertial position and velocity, respectively, of the extraterrestrial vehicle 110 with respect to the central body. The Cartesian acceleration vector due to J2, a_{J2}, can be expressed in components of the RTN frame as

$${a}_{{J}_{2}} = \frac{μ {J}_{2} {R}_{e}^{2}}{{r}^{4}} [ \begin{matrix} & \frac{3}{2} ( 1 - \frac{12 {( h sin L - k cos L )}^{2}}{{( 1 + {h}^{2} + {k}^{2} )}^{2}} ) \\ 12 & ( \frac{( h sin L - k cos L ) ( h cos L + k sin L )}{{( 1 + {h}^{2} + {k}^{2} )}^{2}} ) \\ & 6 \frac{( 1 - {h}^{2} - {k}^{2} ) ( h sin L - k cos L )}{{( 1 + {h}^{2} + {k}^{2} )}^{2}}\end{matrix} ] \qquad ( 6 )$$

where J₂ is the obliquity of the central body and Rₑ is the radius of the central body. The distance of the extraterrestrial vehicle 110 from the central body, r, can be determined by the terrestrial-based computing system 120 as a function of MEEs as r=p/w. Acceleration due to J₂ can be modeled by the terrestrial-based computing system 120 assuming the oblateness of Earth is inertial fixed in the EME2000 frame. The gravitation influence of other primary bodies on the extraterrestrial vehicle 110 can also be modeled by the terrestrial-based computing system 120 in simulation (e.g., based on sensor measurements obtained from equipment located terrestrially and/or in space). The acceleration of the extraterrestrial vehicle 110 due to the gravity of a third body can be defined as

$${a}_{{3}_{j}} = - {μ}_{j} ( \frac{{r}_{js}}{{‖ {r}_{js} ‖}^{3}} + \frac{{r}_{j}}{{‖ {r}_{j} ‖}^{3}} ) \qquad ( 7 )$$

where μ_{3b} is the gravitational parameter of the third body, rⱼ is the position of the third body with respect to the central body, and rⱼₛ is the position of the extraterrestrial vehicle 110 with respect to the third body, defined as r−rⱼ. The terrestrial-based computing system 120 may add this perturbation for each third body considered in the simulation.

The terrestrial-based computing system 120 can further define a mapping to transform components of a Cartesian acceleration vector expressed in the RTN frame to corresponding rates-of-change of MEEs. This mapping can be a time-varying matrix denoting the control influence matrix, B, and can be calculated by the terrestrial-based computing system 120 as a function of the state of the extraterrestrial vehicle 110 as

$$B = \sqrt{\frac{p}{μ}} [ \begin{matrix}0 & 2 p / w & 0 \\ sin ( L ) & ( ( w + 1 ) cos ( L ) + f ) / w & g ( k cos ( L ) - h sin ( L ) ) / w \\ - cos ( L ) & ( ( w + 1 ) sin ( L ) + g ) / w & f ( h sin ( L ) - k cos ( L ) ) / w \\ 0 & 0 & {s}^{2} cos ( L ) / ( 2 w ) \\ 0 & 0 & {s}^{2} sin ( L ) / ( 2 w ) \\ 0 & 0 & ( h sin ( L ) - k cos ( L ) ) / w\end{matrix} ] \qquad ( 8 )$$

where s²=1+h²+k². Using this mapping, the terrestrial-based computing system 120 can calculate the total equations of motion of the extraterrestrial vehicle 110 expressed using MEEs as follows:

$$\frac{d x}{dt} = f + B ( {σ}_{e} u + {a}_{{J}_{2}} + {\sum }_{i = 1}^{N} {a}_{3 , i} ) \qquad ( 9 )$$

The terrestrial-based computing system 120 may numerically integrate these equations of motion to propagate a trajectory during numerical simulations. For example, a 7th-order Runge-Kutta method can be used by the terrestrial-based computing system 120 to generate the presented results. Optionally, during numerical integration, no scaling or nondimensionalization of units may be performed by the terrestrial-based computing system 120.

The terrestrial-based computing system 120 can apply a smoothed eclipse model to throttle down an extraterrestrial vehicle 110 during penumbra shadows. The smoothness of the eclipse model may help maintain continuous partial derivatives used for indirect optimization.

To compute the boundary of the penumbra cone, the projection, rₚ of the position vector of the extraterrestrial vehicle 110 onto the Sun-central body line is calculated by the terrestrial-based computing system 120 as follows:

$${r}_{p} = ( {r}^{T} \hat{s} ) \hat{s} \qquad ( 10 )$$

where the Sun position unit vector from the central body can be defined as ŝ=rₛ/∥rₛ∥. Using this projection vector, the distance between the center of the penumbra cone and the extraterrestrial vehicle 110 can be defined as

$$δ = ‖ r - {r}_{p} ‖ \qquad ( 11 )$$

Next, the terrestrial-based computing system 120 can calculate the distance between the extraterrestrial vehicle 110 and the penumbra edge as follows:

$$κ = ( {χ}_{p} + ‖ {r}_{p} ‖ ) tan ( {α}_{p} ) \qquad ( 12 )$$

where χ is the distance between the center of the central body and the penumbra inflection point, defined as

$${χ}_{p} = \frac{{R}_{e} ‖ {r}_{s} ‖}{{R}_{e} + {R}_{s}} \qquad ( 13 )$$

where Rₑ is the radius of the central body and Rₛ is the radius of the Sun. The penumbra cone angle, α, can be defined as

$$α = {sin}^{- 1} ( {R}_{e} / {χ}_{p} ) \qquad ( 14 )$$

With these definitions, the terrestrial-based computing system 120 considers the extraterrestrial vehicle 110 to be within the penumbra of the central body when δ−κ<0 and r^{T}ŝ<0.

To construct a smooth eclipse throttle factor, the terrestrial-based computing system 120 can construct a combination of two hyperbolic tangent activation functions. The first hyperbolic tangent function may smoothly represent if the extraterrestrial vehicle 110 is on the far side of the central body from the Sun (or other star). The second hyperbolic tangent function may smoothly represent if the extraterrestrial vehicle 110 is within the penumbra cone. Together, the smoothed eclipse model throttling factor, σ, can be defined as

$${σ}_{e} = ( \frac{1 + tanh ( - {k}_{1} {r}^{T} \hat{s} )}{2} ) ( \frac{1 + tanh ( {k}_{2} ( k - δ ) )}{2} ) \qquad ( 15 )$$

where k₁ and k₂ may be user-specified slope values that determine the steepness of the smooth eclipse approximation. For example, as the value of k increases, the steepness of the transition between throttle off and throttle on may increase. During optimization, the terrestrial-based computing system 120 may fix (e.g., hold constant) the eclipse slope values and continuation of the slope values may be optional.

As described herein, the terrestrial-based computing system 120 uses an indirect optimization formulation to minimize either transfer time or propellant usage over a low-thrust transfer. Furthermore, the indirect optimization formulation implemented by the terrestrial-based computing system 120 is an improvement over other indirect optimization formulations implemented by conventional computing systems via the use of orbit averaging, as described in greater detail below.

Optionally, the terrestrial-based computing system 120 may omit at least some perturbations from the derivation of the Hamiltonians used to derived optimal thrust in order to improve robustness to the initial costate values during numerical corrections. For both minimum time and minimum propellant cases, two-body dynamics and perturbation from J2 may be considered within the Hamiltonians. However, gravitational acceleration from third bodies and the effects on throttle due to eclipses optionally are not considered. Omitting the perturbations may result in the terrestrial-based computing system 120 realizing a significant improvement to robustness and/or rate of convergence as compared to conventional computing systems that attempt to use indirect optimization or any of the other methods described above.

For a situation in which the terrestrial-based computing system 120 is attempting to determine a minimum time transfer, the terrestrial-based computing system 120 may determine both the transfer time and the direction of control over time. The cost function, J, minimized during a minimum time transfer can be defined as

$$J = {\int }_{{t}_{0}}^{{t}_{f}} 1 d t \qquad ( 16 )$$

where t₀ and t_{f} are the initial time and final time of the transfer, respectively. The corresponding optimal control Hamiltonian for this cost function can be defined as

$$H = 1 + {λ}_{x}^{T} ( f + B u ) + {λ}_{m} \dot{m} \qquad ( 17 )$$

where λₘ is the costate corresponding with the mass of the extraterrestrial vehicle 110, u is the acceleration due to the control of the extraterrestrial vehicle 110, and λₓ is a 6×1 vector of costates corresponding to the MEE state representation of the extraterrestrial vehicle 110, defined as

$${λ}_{x} = [ {λ}_{p} , {λ}_{f} , {λ}_{g} , {λ}_{h} , {λ}_{k} , {λ}_{L} ] \qquad ( 18 )$$

Within the Hamiltonian for minimum time optimization, control acceleration can be defined as

$$u = ( T / m ) \hat{u} \qquad ( 19 )$$

where T is the maximum thrust of the extraterrestrial vehicle 110 and û is the thrust direction unit vector. The control direction that minimizes this Hamiltonian can be defined as

$$\hat{u} = \frac{{B}^{T} {λ}_{x}}{‖ {B}^{T} {λ}_{x} ‖} \qquad ( 20 )$$

For minimum time optimization, the terrestrial-based computing system 120 assumes that the extraterrestrial vehicle 110 is always applying the maximum thrust magnitude.

The terrestrial-based computing system 120 can evaluate the control direction over a trajectory by simultaneously propagating the costates with the extraterrestrial vehicle 110 states using an augmented state vector. The terrestrial-based computing system 120 can define the rate of change of the costates as a function of the partial derivative of the Hamiltonian with respect to the corresponding extraterrestrial vehicle 110 state as

$${\dot{λ}}_{x} = - \partial H / \partial x \qquad ( 21 a )$$

$${\dot{λ}}_{m} = - \partial H / \partial m \qquad ( 21 b )$$

The terrestrial-based computing system 120 can calculate the partial derivatives of the Hamiltonian with respect to the state and mass of the extraterrestrial vehicle 110 during numerical integration via automatic differentiation. For example, the terrestrial-based computing system 120 can use forward accumulation or reverse accumulation to calculate the partial derivatives of the Hamiltonian with respect to the state and mass of the extraterrestrial vehicle 110 during numerical integration.

For a situation in which the terrestrial-based computing system 120 is attempting to determine a minimum propellant transfer, the terrestrial-based computing system 120 may determine a transfer that minimizes the amount of propellant used over the transfer with a fixed-transfer time. The cost function, J, optimized during a minimum propellant transfer can be expressed as

$$J = - {\int }_{{t}_{0}}^{{t}_{f}} \dot{m} d t \qquad ( 22 )$$

where t_{f}−t₀ is a fixed transfer time specified by the user of the terrestrial-based computing system 120. The corresponding Hamiltonian can be defined as

$$H = - \dot{m} + {λ}_{x}^{T} ( f + B u ) + {λ}_{m} \dot{m} \qquad ( 23 )$$

Within the derivation of the optimal control law for a minimum propellant transfer, the terrestrial-based computing system 120 can determine the mass flow rate of the extraterrestrial vehicle 110 in terms of the control acceleration vector, u, as

$$\dot{m} = - \frac{‖ u ‖ m}{{v}_{e}} \qquad ( 24 )$$

Within the Hamiltonian for minimum time optimization, the terrestrial-based computing system can determine control acceleration as follows:

$$u = σ ( T / m ) \hat{u} \qquad ( 25 )$$

where δ is throttle ∈[0, 1]. The terrestrial-based computing system 120 can select the optimal value of throttle, δ, to minimize the Hamiltonian. To determine the throttle that minimizes the Hamiltonian, the terrestrial-based computing system 120 can run a switching function, s, defined as

$$s = \frac{{v}_{e} ‖ {B}^{T} {λ}_{x} ‖}{m} + {λ}_{m} - 1 \qquad ( 26 )$$

The terrestrial-based computing system 120 can use the switching function to determine a piecewise definition for a throttle profile as follows:

$$σ = \{ \begin{matrix}1 , & s > 0 \\ 0 , & s < 0\end{matrix} \qquad ( 27 )$$

This definition for throttle may assume that the switching function does not possess a value of zero over a finite time. Optionally, the terrestrial-based computing system 120 may not consider throttling due to eclipsing within the Hamiltonian. The control direction, û, defined in Equation (20), may also be used by the terrestrial-based computing system 120 to define the optimal control direction for a minimum propellant transfer.

The optimal throttle profile for a minimum propellant transfer may have a bang-bang profile. However, bang-bang throttle profiles may be prone to sensitivity to costates values and can be discontinuous. As a result, for a true bang-bang profile, spacecraft dynamics do not generally have the continuous partial derivative that is usually involved for numerical integration and Newton's methods. To overcome these technical challenges, the terrestrial-based computing system 120 can determine a hyperbolic tangent smoothing function to the discontinuous mapping between the switching function and throttle. The terrestrial-based computing system 120 can determine the smoothed throttle using a hyperbolic tangent function as follows:

$$σ = \frac{1 - tanh ( k s )}{2} \qquad ( 28 )$$

where s is the switching function defined in Equation (26) and k is a slope factor that determines the steepness of the transition between coast and thrust arcs.

During optimization of minimum propellant transfers, the terrestrial-based computing system 120 can apply a continuation process to iteratively increase the steepness of the transition between coast and thrust arcs. For example, a low value of k can be used by the terrestrial-based computing system 120, corresponding to a smooth, variable throttle profile. Once the terrestrial-based computing system 120 converges upon a solution for a given value of thrust slope, k, the terrestrial-based computing system 120 multiplies the thrust slope by a multiplier. The terrestrial-based computing system 120 may identify a new solution with the thrust slope. The terrestrial-based computing system 120 can repeat this process until the thrust slope is sufficiently large and the throttle profile resembles a nearly-bang-bang profile. The terrestrial-based computing system 120 can apply this continuation process during the orbit average phase to reduce computation time and improve overall robustness.

The terrestrial-based computing system 120 can perform orbit averaging to robustly generate an initial guess for an optimal transfer in full state dynamics. Use of orbit averaging may increase the convergence radius for the initial guess for costates by reducing sensitivity. Furthermore, numerical integration (e.g., using automatic differentiation) of the averaged equation of motion is generally faster than full-state integration and enables the terrestrial-based computing system 120 to rapidly explore the solution space. The functionality of the terrestrial-based computing system 120 described herein can result in a robust hand-off between optimization in averaged dynamics and full dynamics by defining orbit averaging to average the full optimal control problem. Using this formulation, the orbit averaged problem is not minimized specifically. However, the result enables the terrestrial-based computing system 120 to continue the results of the averaged step to a full-state solution in a single step.

For example, the orbit averager 122 of the terrestrial-based computing system 120 can derive an equation of motion for the extraterrestrial vehicle 110. For example, the orbit average 122 may derive the equation of motion by averaging the full-state equations of motion applying the indirect optimal control strategy (e.g., indirect optimization). In this way, the equation of motion may be an averaged equation of motion. In some cases, the equation of motion may be a real-time equation of motion of the vehicle, a predicted equation of motion of the vehicle, or another type of equation of motion with respect to dynamics of the vehicle. This process may be the same whether the terrestrial-based computing system 120 is attempting to determine a minimum time transfer or a minimum propellant transfer. Initially, the orbit averager 122 may determine an augmented state vector (e.g., a 14×1 augmented state vector), y, that includes the state of the extraterrestrial vehicle 110, defined in MEEs, mass, and costates as follows:

$$y = {[ p , f , g , h , k , L , m , {λ}_{p} , {λ}_{f} , {λ}_{g} , {λ}_{h} , {λ}_{k} , {λ}_{L} , {λ}_{m} ]}^{T} \qquad ( 29 )$$

Next, the orbit averager 122 may determine an averaged augmented state vector (e.g., a 12×1 averaged augmented state vector), y̅, without true longitude, L, and the corresponding costate, λ_{L}, as follows:

$$\overline{y} = {[ p , f , g , h , k , m , {λ}_{p} , {λ}_{f} , {λ}_{g} , {λ}_{h} , {λ}_{k} , {λ}_{m} ]}^{T} \qquad ( 30 )$$

The orbit averager 122 can further determine the averaged equations of motion as follows:

$$\frac{d \overline{y}}{dt} = \frac{1}{P} {\int }_{0}^{2 π} \frac{d y}{dt} \frac{dt}{d L} d L , {y}_{i} ∉ [ L , \dot{L} ] \qquad ( 31 )$$

where P is the period of the orbit defined by the averaged orbit y̅, defined as P=2π\sqrt{a³/μ}, where a is the average semi-major axis, defined in terms of MEEs as p/(1−f²−g²). The term dt/dL may be equivalent to the inverse of the rate of change or true longitude, \dot{L}, which the orbit averager 122 calculates within the equations of motion, dy/dt. When evaluating the full equations of motion, the orbit averager 122 may evaluate the costate corresponding to true longitude, λ_{L}, as zero. The orbit averager 122 can approximate the integral in Equation (31) by sampling a finite number of states and applying a trapezoidal integration method.

To initialize optimization for the averaged orbit dynamics, the orbit averager 122 can define a standard guess of the initial costate as a function of the transfer's boundary conditions. For both minimum time and minimum propellant averaged problems, the orbit averager 122 uses the following as the initial guess:

$${λ}_{p , 0} = \{ \begin{matrix}- ϵ , & {p}_{f} - {p}_{0} \geq 0 \\ ϵ , & {p}_{f} - {p}_{0} < 0\end{matrix} \qquad ( 32 )$$

where c is a small, nonzero value that may not involve intensive tuning. The orbit averager 122 may set the initial guess for the initial value of all other costates to be zero. For minimum time transfers, the orbit averager 122 may receive an initial guess of the transfer time provided via user input. However, due to the wide radius of convergence enabled by orbit averaging, the ability of the terrestrial-based computing system 120 to converge to the optimal transfer time may be robust to this user-provided transfer time.

Once the orbit averager 122 identifies a TPBVP solution for an optimal transfer in averaged orbit dynamics, the trajectory optimizer 124 can use the initial costates in the averaged optimal transfer as the initial guess for the initial costates in full-state dynamics. For this transition, the trajectory optimizer 124 can set the initial guess of the initial value of λ_{L} in the full-state dynamics problem to be zero. For minimum time transfers, the trajectory optimizer 124 can use the transfer time of the averaged solution as the initial guess for transfer time in the full state problem. Additionally, if a solution for initial costates for the full-state optimization problem is available, the some or all of the operations performed by the orbit averager 122 can be skipped.

The terrestrial-based computing system 120 formulates the indirect optimization problem in both average and full-state dynamics as TPBVP, solving the problem via a single shooting technique. Specifically, the terrestrial-based computing system 120 can apply multivariate root solvers to solve for a set of variables V that minimize a set of constraints defined within a constraints vector, F. The terrestrial-based computing system 120 can define each constraint such that the respective constraint is satisfied when the respective constraint equals zero when evaluated at the set of free variables.

In some examples, the single shooting technique may involve the steps as described herein. For example, the single shooting technique may start with initial control parameters, such as thrust direction and magnitude, or an initial velocity change (delta-v) for a maneuver of the extraterrestrial vehicle 105, 110. In some examples, the terrestrial-based computing system 120 may propagate a trajectory forward in time of the extraterrestrial vehicle 105, 110. For example, the propagation may involve using numerical integration methods with respect to the guessed parameters (e.g., Runge-Kutta). In some examples, the terrestrial-based computing system 120 may evaluate an endpoint by comparing a final state of the propagated trajectory with desired final conditions (for example, specific position and velocity in the target orbit). In this way, if the final state fails to meet the desired conditions, the terrestrial-based computing system 120 may adjust the initial conditions (or control parameters) to meet the desired conditions. The adjustment may be done using optimization algorithms, for example, gradient descent or another method for finding roots of the control system representing the extraterrestrial vehicle 105, 110. The terrestrial-based computing system 120 may repeat the propagation and adjustment steps iteratively until the final state of the trajectory meets the desired endpoint conditions within a specified tolerance.

The free variables and constraints for TPBVPs may be as follows: for average minimum propellant, the free variables may be 5 initial average MEE costates and 1 initial mass costate, and the constraints may be 5 final state boundary constraints and 1 mass costate transversality condition; for average minimum time, the free variables may be 5 initial average MEE costates, 1 initial mass costate, 1 transfer time, and 1 slack variable, and the constraints may be 5 final state boundary constraints, 1 mass costate transversality condition, 1 final Hamiltonian constraint, and 1 time direction constraint; for full-state minimum propellant, the free variables may be 6 initial MEE costates and 1 initial mass costate, and the constraints may be 5 final slow MEE boundary constraints, 1 final fast-variable constraint, and 1 mass costate transversality condition; and for full-state minimum time, the free variables may be 6 initial MEE costates, 1 initial mass costate, 1 transfer time, and 1 slack variable, and the constraints may be 5 final slow MEE boundary constraints, 1 final fast-variable constraint, 1 mass costate transversality condition, 1 final Hamiltonian constraint, and 1 time direction constraint.

In each case, the number of variables may equal the number of constraints. For minimum time optimization, the terrestrial-based computing system 120 can add a slack variable and constraint to enforce positive transfer times. For full-state problems, the trajectory optimizer 124 can add costate associated with true longitude, λ_{L}, to the free variables. With the addition of a new variable, the trajectory optimizer 124 can add the complementary fast-variable constraint to the constraint functions to maintain a fully-defined problem. This fast-variable constraint may be true longitude or the transversality constraint for the costate associated with true longitude, λ_{L,f}=0. In some embodiments, trajectory optimizer 124 improves the convergence of the Newtons' methods by first solving the TPBVP without the fast constraint, then adding the fast constraint and resolving.

The operations performed by the terrestrial-based computing system 120 may not be dependent on a specific root-solving method. Different root-solving methods may be used by the terrestrial-based computing system 120 interchangeably, though convergence performance may vary depending on the implemented algorithm. As an illustrative example, the terrestrial-based computing system 120 can implement a modified version of the Newton's method in which the Jacobian of constraints with respect to variables is computed twice per iteration. In this method, the terrestrial-based computing system 120 can determine the next iteration of variables as follows:

$${V}_{mid} = {V}_{i} - {J ( {V}_{i} )}^{- 1} F ( {V}_{i} ) / 2 \qquad ( 33 a )$$

$${V}_{i + 1} = Vi - {J ( {V}_{mid} )}^{- 1} F ( {V}_{i} ) \qquad ( 33 b )$$

where Jᵢ is Jacobian of constraints with respect to variables, (e.g., Jᵢ=δF (Vᵢ)/δVᵢ, where the partial derivates may be computed by the terrestrial-based computing system 120 using automatic differentiation, as described above). The modified version of this algorithm approximates one the Jacobian evaluations at V_{mid}, via a Broyden's method update on the inverse of the Jacobian. Specifically, the terrestrial-based computing system 120 can determine the inverse of the Jacobian, J(V_{mid})⁻¹, as follows:

$${J ( {V}_{mid} )}^{- 1} \approx {J ( {V}_{i} )}^{- 1} + \frac{Δ V - {J ( {V}_{i} )}^{- 1} Δ F}{Δ {V}^{T} ( {J ( {V}_{i} )}^{- 1} Δ F )} Δ {V}^{T} {J ( {V}_{i} )}^{- 1} \qquad ( 34 )$$

where the differences ΔV and ΔF can be by the terrestrial-based computing system 120 using the midpoint evaluation as ΔV=V_{mid}−Vᵢ and ΔF=F_{mid}−Fᵢ. With this modification, the terrestrial-based computing system 120 can perform a second evaluation of the constraints function instead of a second evaluation of the more computationally expensive Jacobian matrix, balancing performance and computation effort. The terrestrial-based computing system 120 may also implement a line-search process to supplement iterations, which can help convergence for particularly sensitive problems.

The terrestrial-based computing system 120 may iterate Newton's updates until a solution has been found within a threshold tolerance level. For example, the terrestrial-based computing system 120 can check the Euclidean norm of the constraint vector and stop iterating when the norm is less than a user-specified threshold tolerance level. As an illustrative example, for simulations using dimensional quantities of kilometers, seconds, and/or kilograms, the threshold tolerance level may be 10⁻⁴ to 10⁻¹.

### Example Minimum Time or Propellant Transfer Terrestrial-Based Determination Routine

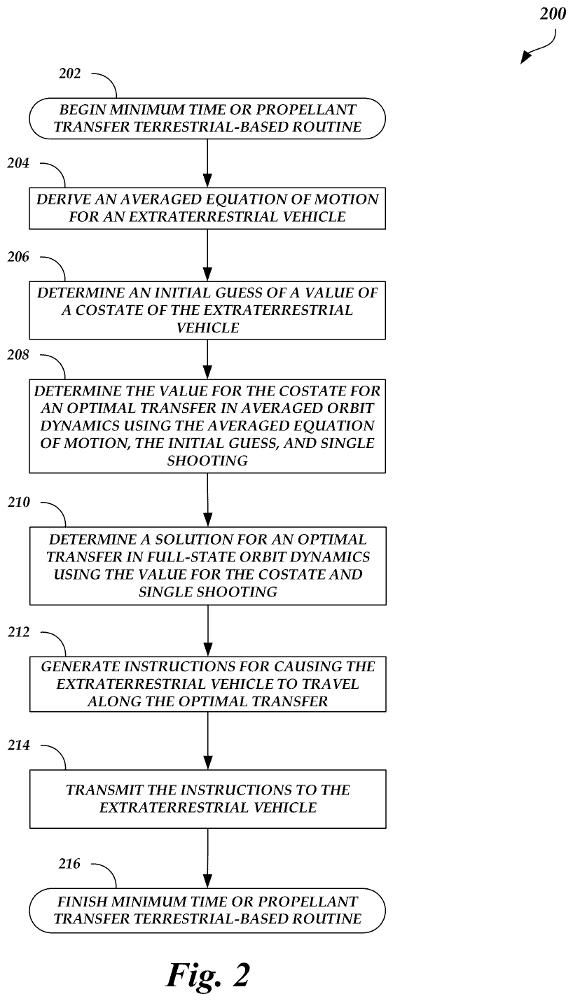

FIG. 2 is a flow diagram depicting an example minimum time or propellant transfer determination routine 200 illustratively implemented by a terrestrial-based computing system, according to one embodiment. As an example, the terrestrial-based computing system 120 of FIG. 1 can be configured to execute the minimum time or propellant transfer determination routine 200. The minimum time or propellant transfer determination routine 200 begins at block 202.

At block 204, an averaged equation of motion for an extraterrestrial vehicle is derived. For example, the averaged equation of motion may be derived for the extraterrestrial vehicle 110. The averaged equation of motion can be derived by averaging the full-state equations of motion applying indirect optimization.

At block 206, an initial guess of a value of a costate of the extraterrestrial vehicle is determined. For example, the costate may be λp. Optionally, initial guesses for the initial value of other costates may be set to 0.

At block 208, the value for the costate for an optimal transfer in averaged orbit dynamics is determined using the averaged equation of motion, the initial guess, and single shooting. For example, the value for the costate can be determined by applying multivariate root solvers to solve for a set of variables V that minimize a set of constraints defined within a constraints vector, F. In further embodiments, values for other costates are also determined for the optimal transfer in averaged orbit dynamics using the averaged equation of motion, initial guesses for those respective costates, and/or single shooting. In addition, partial derivatives to be solved in determining the optimal transfer in averaged orbit dynamics may be solved using automatic differentiation.

At block 210, a solution for an optimal transfer in full-state orbit dynamics is determined using the value for the costate for the optimal transfer in averaged orbit dynamics and single shooting. For example, the solution for the optimal transfer in full-state orbit dynamics may comprise a value for the costate (which may or may not be the same value identified when determining the optimal transfer in averaged orbit dynamics). In determining the solution for the optimal transfer in full-state orbit dynamics, the value of the costate for the optimal transfer in averaged orbit dynamics may be used as an initial guess for the value of the costate for the optimal transfer in full-state orbit dynamics. The value for the costate for the optimal transfer in full-state orbit dynamics can be determined by applying multivariate root solvers to solve for a set of variables V that minimize a set of constraints defined within a constraints vector, F. In further embodiments, values for other costates are also determined for the optimal transfer in full-state orbit dynamics, where the initial guesses for these other costates may be the values of the respective costates resulting from determining the optimal transfer in averaged orbit dynamics. Thus, the value(s) for the costate(s) identified when determining the optimal transfer in averaged orbit dynamics may be used as the initial guess(es) for the value(s) of the costate(s) when determining the optimal transfer in full-state orbit dynamics. In addition, partial derivatives to be solved in determining the optimal transfer in averaged orbit dynamics may be solved using automatic differentiation.

At block 212, instructions for causing the extraterrestrial vehicle to travel along the optimal transfer in full-state orbit dynamics is generated. For example, the instructions may include a path (e.g., defined by a set of coordinates) between point A and point B for the extraterrestrial vehicle to follow, times when the thrust of the extraterrestrial vehicle should be activated or deactivated, and/or the like.

At block 214, the instructions are transmitted to the extraterrestrial vehicle. In some examples, the instructions may cause the extraterrestrial vehicle to adjust trajectory based on the generated instructions. After the instructions are transmitted to the extraterrestrial vehicle, the minimum time or propellant transfer determination routine 200 ends, as shown at block 216.

Because the terrestrial-based computing system 120 described herein can identify minimum time or minimum propellant transfers that are more accurate than transfers identified by typical computing systems, the number of times the terrestrial-based computing system 120 may need to determine a new minimum time or minimum propellant transfer to course-correct the extraterrestrial vehicle 110 may be reduced. As a result, the terrestrial-based computing system 120 may use fewer computational resources and less computational time in navigating the extraterrestrial vehicle 110 from point A to point B along a minimum propellant or minimum time transfer as compared to typical computing systems.

Appendices A and B provide additional detail on how the optimal transfer (e.g., minimum time or minimum propellant transfer) in both averaged orbit dynamics and full-state orbit dynamics can be determined, and the terrestrial-based computing system 120 may be configured to perform any or all of the operations described in Appendices A and B.

### Example Data Flow Interactions With Terrestrial-Based Computing System

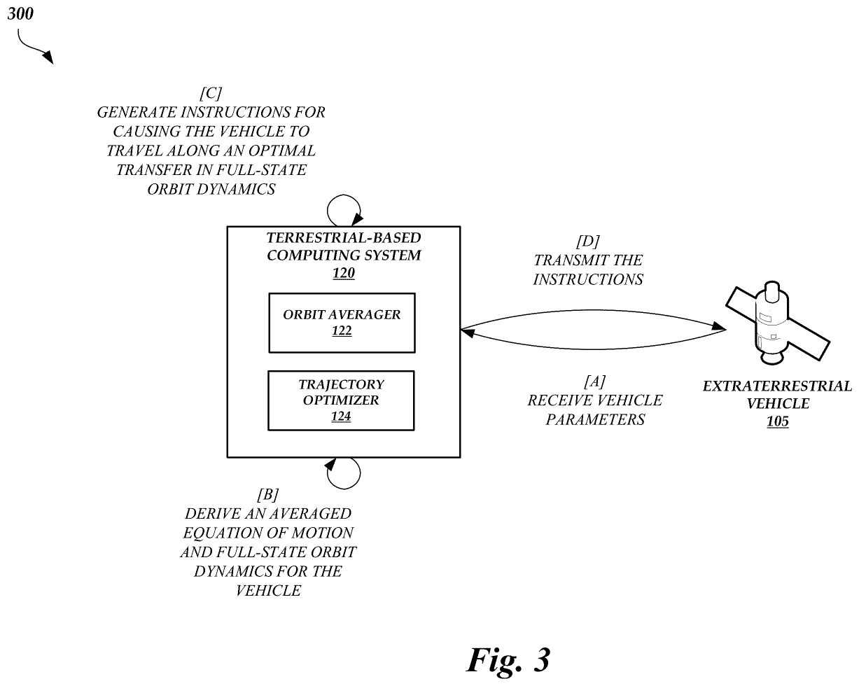

FIG. 3 is a diagram 300 of illustrative data flows and interactions between an extraterrestrial vehicle 105 and a terrestrial-based computing system 120 to determine a trajectory change for the extraterrestrial vehicle 105 to adjust an orbital path.

At [A], the terrestrial-based computing system 120 receives vehicle parameters from the extraterrestrial vehicle 105. In some examples, the terrestrial-based computing system 120 may receive the vehicle parameters by the transmission system 102. In some examples, the vehicle parameters may at least include navigation parameters and/or component parameters. For example, the navigation parameters may include parameters from a navigation system of the extraterrestrial vehicle 105. The navigation parameters may include one or more of location, distance away from the terrestrial-based computing system 120, direction, velocity, proximity from nearest celestial body, or another navigation parameter measured with respect to the extraterrestrial vehicle 105. In some examples, the component parameters may include fuel levels, component health (engines, thrusters, etc.), component performance, predicted capabilities, or another component parameters associated to components of the extraterrestrial vehicle 105.

At [B], the terrestrial-based computing system 120 derives an averaged equation of motion and full-state orbit dynamics for the extraterrestrial vehicle 105. The averaged equation of motion can be derived by averaging the full-state equations of motion applying indirect optimization. The terrestrial-based computing system 120 may obtain an initial guess of a value of a costate of the extraterrestrial vehicle 105 as described herein (such as described in block 206 of FIG. 2). For example, the costate may be λp. In some cases, initial guesses for the initial value of other costates may be set to 0. The terrestrial-based computing system 120 may determine the value for the costate for an optimal transfer in averaged orbit dynamics as described herein (such as described in block 208 of FIG. 2). For example, the terrestrial-based computing system 120 may compute the value using the averaged equation of motion, the initial guess, and single shooting. The terrestrial-based computing system 120 may compute a solution for an optimal transfer in full-state orbit dynamics as described herein (such as described in block 210 of FIG. 2). For example, the solution for the optimal transfer in full-state orbit dynamics may comprise a value for the costate (which may or may not be the same value identified when determining the optimal transfer in averaged orbit dynamics).

At [C], the terrestrial-based computing system 120 generates instructions for causing the extraterrestrial vehicle 105 to travel along an optimal transfer in full-state orbit dynamics. For example, the instructions may include a path (e.g., defined by a set of coordinates) between point A and point B for the extraterrestrial vehicle to follow, times when the thrust of the extraterrestrial vehicle should be activated or deactivated, and/or the like. At [D], the terrestrial-based computing system 120 transmits the instructions to the extraterrestrial vehicle 105.

### Example Space Vehicle Low-Thrust Propulsion System

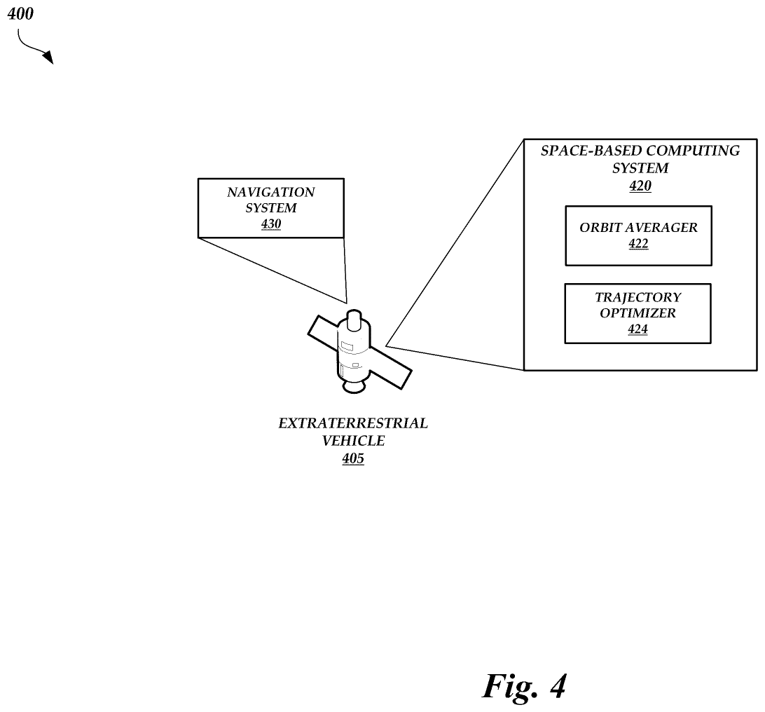

FIG. 4 is a block diagram of an illustrative operating environment 400 in which a space-based computing system 420 determines, for an extraterrestrial vehicle 405, a minimum time or fixed-time, minimum propellant transfer about a central body and/or between orbits using a two-step approach. The extraterrestrial vehicle 405 may be a space lander (e.g., a lander configured to land on a celestial body, such as a moon, a planet, an asteroid, etc.), a rover, a rocket, a satellite, a spaceship, a space shuttle, and/or any other type of vehicle that is capable of operating in space and/or on an extraterrestrial object other than Earth. The extraterrestrial vehicle 405 may also be referred to herein as “spacecraft.” The space-based computing system 420, the averager 422, and the trajectory optimizer 424 may include characteristics as described for the space-based computing system 420, the averager 422, and the trajectory optimizer 424 as described herein, respectively. As described herein, “space” may include outer space or any location outside of Earth's orbit. For example, “space” may be with respect to an extraterrestrial vehicle traveling in LEO, GEO, or interstellar travel in outer space with or without interaction with a terrestrial-based system.

The extraterrestrial vehicle 405 includes a navigation system 430. The navigation system 430 may determine and control the position, velocity, and orientation of the extraterrestrial vehicle 405 in space using onboard components. For example, the navigation system 430 may receive inputs from the space-based computing system 420, which may include inputs from one or more of sensors, a computer, and propulsion systems. In some examples, the sensors may include star trackers, sun sensors, gyroscopes, accelerometers, GPS receivers, and radio tracking systems. The sensor may provide real-time data that the navigation system 430 may process to monitor the trajectory of the extraterrestrial vehicle 405. The propulsion system may include thrusters and main engines. The propulsion system may execute trajectory adjustments based on calculations from the navigation system 430.

When the navigation system 430 adjusts from a first orbit to a second orbit, the navigation system 430 may detect the current trajectory and compute the orbital changes to reach the second orbit. The navigation system 430 may provide sensor data to the space-based computing system 420. In this manner, the space-based computing system 420 may determine the changes in navigation and component parameters and plan the maneuvers. For example, to move from a LEO to a higher orbit, the space-based computing system 420 may calculate a transfer orbit burn with low-thrust engines. The low-thrust engines of the extraterrestrial vehicle 405 then executes the burn to increase velocity, moving the extraterrestrial vehicle 405 into an elliptical transfer orbit. At the apogee of this orbit, another burn is performed to circularize the orbit, achieving the final desired orbit.

### Example Minimum Time or Propellant Transfer Space-Based Determination Routine

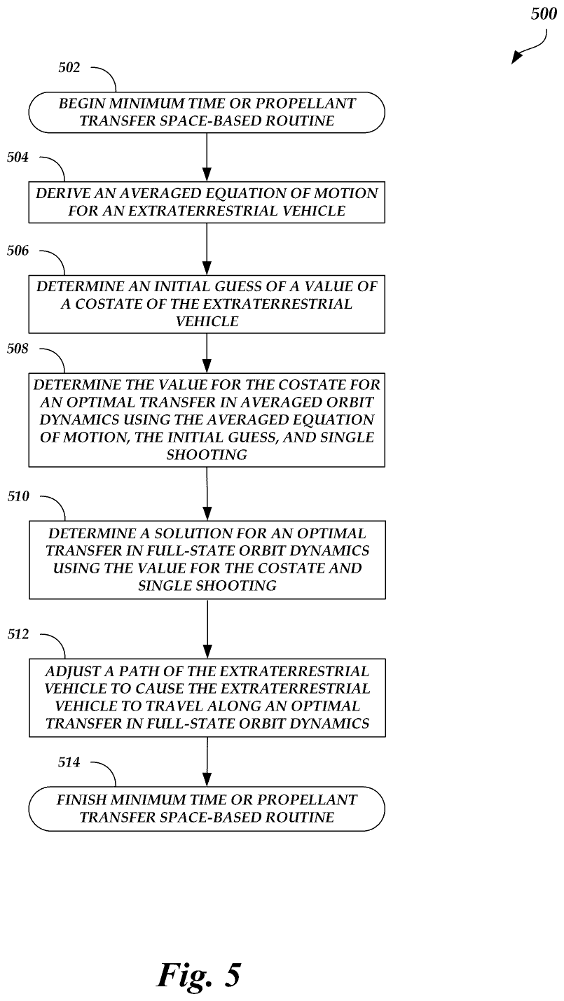

FIG. 5 is a flow diagram depicting an example minimum time or propellant transfer space-based determination routine 500 illustratively implemented by a space-based computing system, according to one embodiment. As an example, the space-based computing system 420 of FIG. 4 can be configured to execute the minimum time or propellant transfer space-based determination routine 500. The minimum time or propellant transfer determination routine 200 begins at block 502.

At block 504, an averaged equation of motion for the extraterrestrial vehicle is derived. The derivation of the averaged equation of motion may have aspects as described herein (for example, as described in block 204 in FIG. 2).

At block 506, an initial guess of a value of a costate of the extraterrestrial vehicle is determined. Determining the initial guess of the value of the costate may have aspects as described herein (for example, as described in block 206 in FIG. 2).

At block 508, the value for the costate for an optimal transfer in averaged orbit dynamics is determined using the averaged equation of motion, the initial guess, and single shooting. Determining the value for the costate may have aspects as described herein (for example, as described in block 208 in FIG. 2).

At block 510, a solution for an optimal transfer in full-state orbit dynamics is determined using the value for the costate for the optimal transfer in averaged orbit dynamics and single shooting. The solution for the optimal transfer may be determined as described herein (for example, as described in block 210 in FIG. 2).

At block 512, a path of the extraterrestrial vehicle is adjusted to cause the extraterrestrial vehicle to travel along an optimal transfer in full-state orbit dynamics. In some examples, the extraterrestrial vehicle activates low-thrust engines to provide thrust to adjust the path. In some cases, the low-thrust engines may provide power at points in the initial orbit to adjust the path to another orbit. For example, to move from a LEO to a higher orbit, the space-based computing system 420 may calculate a transfer orbit burn with low-thrust engines. The low-thrust engines of the extraterrestrial vehicle 405 then executes the burn to increase velocity, moving the extraterrestrial vehicle 405 into an elliptical transfer orbit. At the apogee of this orbit, another burn is performed to circularize the orbit, achieving the final desired orbit. After the extraterrestrial vehicle adjusts the path, the minimum time or propellant transfer space-based determination routine 500 ends, as shown at block 514.

### Example Data Flow Interactions For Space Vehicle

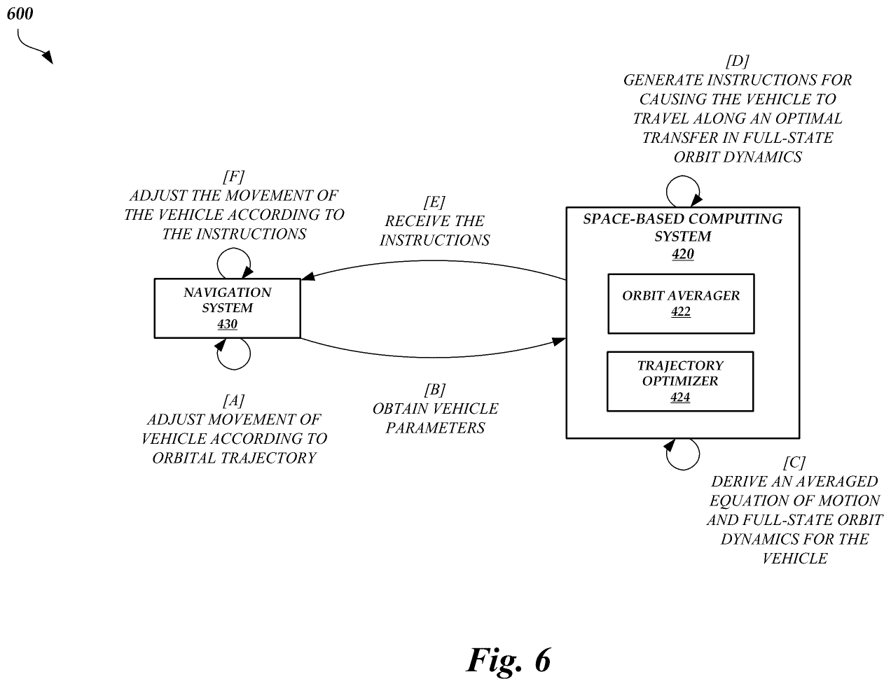

FIG. 6 is a diagram 600 of illustrative data flows and interactions between a space-based computing system 420 and a navigation system 430, each of which may be included onboard an extraterrestrial vehicle 405, to determine a trajectory change for the extraterrestrial vehicle 105 to adjust an orbital path.

At [A], the navigation system 430 adjusts movement of an extraterrestrial vehicle 405 according to orbital trajectory. The engine controls may adjust movement with respect to navigation parameters (for example, increasing or reducing thrust according to the navigation parameters). In some examples, the navigation system 430 provides the navigation parameters to engine controls for adjusting the movement of the extraterrestrial vehicle 405. For example, the navigation system 430 may obtain navigation parameters about position, orientation, speed (and/or velocity), guidance, or another parameter relevant to monitoring movement of the extraterrestrial vehicle 405. The parameters disclosed herein may be with and/or without regards to a celestial body or a location of a terrestrial-based system.

In some cases, the movement of the extraterrestrial vehicle 405 may follow the orbital trajectory. For example, the orbital trajectory may include predetermined orbital characteristics for the extraterrestrial vehicle 405 to follow (for example, orbiting a celestial body). The predetermined characteristics may include variations of the navigation parameters as disclosed herein. In some cases, the extraterrestrial vehicle 405 may move outside of the orbital trajectory (or be at risk of moving outside the orbital trajectory), for example, in response to an external force acting on the extraterrestrial vehicle 405 (being struck by, or coming into close contact with, space debris). In this manner, the navigation system 430 may obtain the navigation parameters and send the navigation parameters to engine controls to adjust the movement of the extraterrestrial vehicle 405.

At [B], the space-based computing system 420 obtains vehicle parameters from the navigation system 430. In some examples, the vehicle parameters may at least include the navigation parameters and/or component parameters. For example, the navigation parameters may include parameters as disclosed herein. In some examples, the component parameters may include fuel levels, component health (engines, thrusters, etc.), component performance, predicted capabilities, or another component parameters associated to components of the extraterrestrial vehicle 405.

At [C], the space-based computing system 420 derives an averaged equation of motion and full-state orbit dynamics for the extraterrestrial vehicle 405. The averaged equation of motion can be derived by averaging the full-state equations of motion applying indirect optimization. The space-based computing system 420 may obtain an initial guess of a value of a costate of the extraterrestrial vehicle 105 as described herein (such as described in block 206 of FIG. 2). For example, the costate may be λp. In some cases, initial guesses for the initial value of other costates may be set to 0. The space-based computing system 420 may determine the value for the costate for an optimal transfer in averaged orbit dynamics as described herein (such as described in block 208 of FIG. 2). For example, the space-based computing system 420 may compute the value using the averaged equation of motion, the initial guess, and single shooting. The space-based computing system 420 may compute a solution for an optimal transfer in full-state orbit dynamics as described herein (such as described in block 210 of FIG. 2). For example, the solution for the optimal transfer in full-state orbit dynamics may comprise a value for the costate (which may or may not be the same value identified when determining the optimal transfer in averaged orbit dynamics).

At [D], the space-based computing system 420 generates instructions for causing the extraterrestrial vehicle 405 to travel along an optimal transfer in full-state orbit dynamics. For example, the instructions may include a path (e.g., defined by a set of coordinates) between point A and point B for the extraterrestrial vehicle to follow, times when the thrust of the extraterrestrial vehicle should be activated or deactivated, and/or the like. At [E], the navigation system 430 receives the instructions.

At [F], the navigation system 430 adjusts the movement of the extraterrestrial vehicle 405 according to the generated instructions. In some examples, the navigation system 430 may provide the parameters to the engine controls for adjusting the movement of the extraterrestrial vehicle 405 as disclosed herein. For example, the engine controls may adjust movement with respect to the navigation parameters from the navigation system 430 (for example, increasing or reducing thrust according to the navigation parameters). The generated instructions may cause the navigation system 430 to update the parameters with respect to another orbital trajectory. For example, the updated orbital trajectory may be different than the original orbital trajectory. In this way, the extraterrestrial vehicle 405 may move from the original orbital trajectory to the updated orbital trajectory. The change in orbital trajectories may rely on activating the low-thrust engines at specified times along the original orbital trajectories to adjust the movement of the extraterrestrial vehicle 405 to the updated orbital trajectory. For example, to move from a LEO to a higher orbit, the space-based computing system 420 may calculate a transfer orbit burn with low-thrust engines. The low-thrust engines of the extraterrestrial vehicle 405 then executes the burn to increase velocity, moving the extraterrestrial vehicle 405 into an elliptical transfer orbit. At the apogee of this orbit, another burn is performed to circularize the orbit, achieving the final desired orbit.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements, or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A vehicle capable of operating in space, the vehicle comprising:
a memory that stores computer-executable instructions; and
a processor in communication with the memory, wherein the computer-executable instructions, when executed by the processor, cause the processor to:
derive an equation of motion for the vehicle;
determine an initial guess of a first value of a costate of the vehicle;
determine the first value of the costate for a minimum propellant transfer in averaged orbit dynamics using the equation of motion, the initial guess, and a single shooting technique;
determine a second value of the costate for the minimum propellant transfer in full-state orbit dynamics using the first value of the costate and the single shooting technique; and
adjust a path of the vehicle to cause the vehicle to travel along an optimal transfer in full-state orbit dynamics.

2. The vehicle of claim 1, wherein the computer-executable instructions, when executed by the processor, further cause the processor to determine the initial guess of the first value of the costate of the vehicle as corresponding to trajectory boundary conditions of the vehicle.

3. The vehicle of claim 1, wherein the computer-executable instructions, when executed by the processor, further cause the processor to determine the second value of the costate in the full-state orbit dynamics using the first value of the costate and the single shooting technique by applying multivariate root solvers to solve for a set of variables that minimize a set of constraints defined within a constraints vector.

4. The vehicle of claim 1, wherein the computer-executable instructions, when executed by the processor, further cause the processor to generate the instructions for causing the vehicle to travel along the optimal transfer in the full-state orbit dynamics including a path between an initial position and a final position for the vehicle to follow, wherein the path corresponds to the vehicle using minimum propellant to reach the final position.

5. A non-transitory, computer-readable medium comprising computer-executable instructions, wherein the computer-executable instructions, when executed by a computer system, cause the computer system to:
derive an equation of motion for an vehicle;
determine an initial guess of a first value of a costate of the vehicle;
determine the first value of the costate for a minimum propellant transfer in averaged orbit dynamics using the equation of motion, the initial guess, and a single shooting technique;
determine a second value of the costate for the minimum propellant transfer in full-state orbit dynamics using the first value of the costate and the single shooting technique;
generate instructions for causing the vehicle to travel along an optimal transfer in full-state orbit dynamics; and
adjust a path of the vehicle to cause the vehicle to travel along an optimal transfer in full-state orbit dynamics.

6. The non-transitory, computer-readable medium of claim 5, wherein the computer-executable instructions further include instructions, when executed by a computer system, cause the computer system to determine the initial guess of the first value of the costate of the vehicle as corresponding to trajectory boundary conditions of the vehicle.

7. The non-transitory, computer-readable medium of claim 5, wherein the computer-executable instructions further include instructions, when executed by a computer system, cause the computer system to determine the second value of the costate in the full-state orbit dynamics using the first value of the costate and the single shooting technique by applying multivariate root solvers to solve for a set of variables that minimize a set of constraints defined within a constraints vector.

8. The non-transitory, computer-readable medium of claim 5, wherein the computer-executable instructions further include instructions, when executed by a computer system, cause the computer system to generate the instructions for causing the vehicle to travel along the optimal transfer in the full-state orbit dynamics including a path between an initial position and a final position for the vehicle to follow, wherein the path corresponds to the vehicle using minimum propellant to reach the final position.

9. The non-transitory, computer-readable medium of claim 5, wherein the computer-executable instructions further include instructions, when executed by a computer system, cause the computer system to determine a user-specified transfer time when the averaged orbit dynamics derives in response to minimizing propellant usage for the vehicle.

10. The non-transitory, computer-readable medium of claim 9, wherein the computer-executable instructions further include instructions, when executed by a computer system, cause the computer system to determine the first value of the costate in the averaged orbit dynamics using the equation of motion, the initial guess, the single shooting, and the user-specified transfer time.

11. The non-transitory, computer-readable medium of claim 5, wherein the computer-executable instructions further include instructions, when executed by a computer system, cause the computer system to determine the first value of the costate in the averaged orbit dynamics by solving a two-point boundary value problem with the equation of motion and the initial guess as inputs, wherein the two-point boundary value problem is solved with the single shooting technique.

12. The non-transitory, computer-readable medium of claim 5, wherein the computer-executable instructions further include instructions, when executed by a computer system, cause the computer system to determine the first value of the costate for the minimum propellant transfer over a fixed-transfer time in the averaged orbit dynamics using the equation of motion, the initial guess, and the single shooting technique.

13. A computer-implemented method for determining a trajectory for an vehicle, the method comprising:
deriving an equation of motion for the vehicle;
determining an initial guess of a first value of a costate of the vehicle;
determining the first value of the costate for a minimum propellant transfer in averaged orbit dynamics using the equation of motion, the initial guess, and a single shooting technique;
determining a second value of the costate for the minimum propellant transfer in full-state orbit dynamics using the first value of the costate and the single shooting technique;
generating instructions for causing the vehicle to travel along an optimal transfer in full-state orbit dynamics; and
adjusting a path of the vehicle to cause the vehicle to travel along an optimal transfer in full-state orbit dynamics.

14. The method of claim 13, wherein determining the initial guess of the first value of the costate comprises determining the initial guess of the first value of the costate of the vehicle as corresponding to trajectory boundary conditions of the vehicle.

15. The method of claim 13, wherein determining the second value of the costate in the full-state orbit dynamics using the first value of the costate and the single shooting technique comprises determining the second value of the costate in the full-state orbit dynamics using the first value of the costate and the single shooting technique by applying multivariate root solvers to solve for a set of variables that minimize a set of constraints defined within a constraints vector.

16. The method of claim 13, wherein generating instructions for causing the vehicle to travel along the optimal transfer in the full-state orbit dynamics comprises generating the instructions for causing the vehicle to travel along the optimal transfer in the full-state orbit dynamics including a path between an initial position and a final position for the vehicle to follow, wherein the path corresponds to the vehicle using minimum propellant to reach the final position.

17. The method of claim 13, further comprising determining a user-specified transfer time when the averaged orbit dynamics derives in response to minimizing propellant usage for the vehicle.

18. The method of claim 17, further comprising determining the first value of the costate in the averaged orbit dynamics using the equation of motion, the initial guess, the single shooting, and the user-specified transfer time.

19. The method of claim 13, wherein determining the first value of the costate in the averaged orbit dynamics using the equation of motion, the initial guess, and the single shooting comprises determine the first value of the costate in the averaged orbit dynamics by solving a two-point boundary value problem with the equation of motion and the initial guess as inputs, wherein the two-point boundary value problem is solved with the single shooting technique.

20. The method of claim 13, wherein determining the first value of the costate for the minimum propellant transfer in the averaged orbit dynamics using the equation of motion, the initial guess, and the single shooting technique comprises determining the first value of the costate for the minimum propellant transfer over a fixed-transfer time in the averaged orbit dynamics using the equation of motion, the initial guess, and the single shooting technique.
